(19) United States
(12) Patent Application Publication
(10) Pub. No.: US 2023/0351364 A1
(43) Pub. Date: Nov. 2, 2023

(54) SYSTEM AND PROCESS FOR GIFT PACKAGE OF A PREPAID CARD AND A WEARABLE DEVICE

(71) Applicant: INAMO Inc., Santa Monica, CA (US)

(72) Inventor: Peter John COLBERT, Lane Cove (AU)

(21) Appl. No.: 17/733,894

(22) Filed: Apr. 29, 2022

(51) Int. Cl. G06Q 20/32; G06Q 20/20

(52) U.S. Cl. CPC G06Q 20/3274; G06Q 20/321; G06Q 20/3229; G06Q 20/204

(57) ABSTRACT

A process and apparatus for creating and using a money gift package in which a recorded message from a Giver can be retrieved by a Recipient. A wearable personable implement such as a wrist band contains an attached SIM Card that is used without contact to activate a point-of-sale terminal. A QR Code is used to provide access to the recorded message as well as instructional messages and contains the identity of the Giver and the Recipient.

### FIELD OF THE INVENTION

The disclosure generally relates to a system and method of using intelligent cards, such as credit and debit cards, in electronic transactions through a wearable mobile device. A SIM card that can be loaded with a transactional amount and storage location is used in combination with a personal implement such as a wrist band that in turn is used with a conventional intelligent credit card reader, or point-of-sale terminal.

### BACKGROUND OF THE INVENTION

When one person desires to give a present of money to another, the conventional ways are to use a check or cash. Also, that person could allow the other person to use his or her intelligent card. Intelligent cards include a credit card, a debit card, a stored value card, a loyalty card, or a virtual currency indicator. Further, the Giver could purchase a pre-paid or pre-loaded intelligent card and give the card to the recipient. The intelligent cards are usually issued by a bank, credit union, retailer, or vendor, and can be specific for an item such as clothing or can be in general and provide a maximum monetary amount that can be charged.

To indicate who the Giver is, that person can accompany the gift by using a greeting card. The transaction can be completed by mailing or sending by courier the greeting card containing the money, a check, or a prepaid card. In addition, the transaction can be simply personally handing the money or prepaid card and greeting card to the other person. Also, the Giver can electronically transfer funds from his or her bank account to the bank account of the other.

All of the foregoing methods of transferring money to another are mostly impersonal and a special message usually cannot be used except on a greeting card. Further, the quantity, differences and complexity of the intelligent cards makes their organization and redemption difficult and confusing.

Preloaded intelligent cards can also be perceived as being a lazy or impersonal type of gift. They can typically be obtained only by visiting the issuing business, such as a drug store. This procedure is impersonable and not always convenient or desirable. Most donors would prefer to give a greeting that has meaning and is connected to the recipient. Therefore, there is a need for providing customizable and personalized gift options to recipients.

Historically, intelligent cards have been embodied in a physical object, such as a plastic card. These cards are susceptible to loss, misplacement, or theft. It would therefore be helpful if the intelligent card could be attachable to the user, such as on a bracelet.

Accordingly, there is also a need to have a convenient wearable mobile device that will not be easily lost or misplaced and that is easy to use or keep track of.

A few years ago, an Australian Company participated in a pilot project with VISA Australia to promote a “pay-by-sunglasses” program. In this program, a payment SIM card was initially provided in a plastic card, was then popped out of the plastic card, and was glued to the arm of a pair of sunglasses. The sunglasses were then used to contactless energize a consumer point-of-sale terminal.

### SUMMARY OF THE DISCLOSURE

In one specific aspect, systems and methods are disclosed for producing or obtaining a gift card program and giving it as a gift to a recipient. The gift can be one for an anniversary, birthday, holidays such as Christmas and Valentine's Day, Get well, graduation, kids in college, Mother's and Father's Day, Thank you cards, and business contact cards.

The gift card program comprises a wearable personal device such as a wrist band or bracelet and comprises a portable plastic or flexible card that contains a recordable and playable QR code and a removable SIM card. The Giver's personal computer or mobile smart phone is used to create and then print a QR code on the plastic card. The QR Code contains a personal voice or video message. The personal computer also adds the money to the SIM card.

The gift card program is personalized by having a Giver use the mobile smart phone to record a message or a video on the QR code. The QR code can then later be read, for example, by the recipient's smart phone. The SIM card is preloaded with money from a preferably newly opened dedicated personal bank account. The recipient of the gift package reads the message and/or video on the QR code using his or her cell phone, and then removes the SIM card and inserts it into the bracelet. From there, the bracelet can be used without contact at a customer point-of-sale terminal.

To produce the gift card program in a specific method, the Giver purchases a wrist band and a payment SIM card having a QR code and a removable SIM chip on it. Then using the Giver's computer or mobile phone, the Giver creates a bank account and selects the load amount, usually between $25 and $500, but it can be any amount that a bank will allow. On a downloadable program from the QR code, the Giver completes the Giver's name, email and mobile phone number and the Recipient's name, email, and delivery address. Then the Giver records a video or a statement using his or her smart phone or personal computer and stores it in the cloud. The video or statement location is recorded onto the QR code, and the wrist band and payment SIM card are sent to the Recipient, usually through the postal system or express delivery system, or hand delivered. Written instructions are also included telling the Recipient to use for example his or her cell phone to read the QR code.

The Recipient upon receiving the wrist band and payment SIM card follows the accompanying instructions and reads the QR code and the stored instructions and greeting. The Recipient then removes the SIM card chip and inserts it into the elastic wristband or bracelet. Then the present is complete, All the Recipient now has to do is to select his or her purchases, go to a point-of-sale (POS) terminal, and use the bracelet with the attached SIM card chip to make a contactless payment.

In a more specific embodiments of the invention, a corporation utilizes a general gift card program that can be used to reward employees. Also, an individual Giver can use a specific program to individualize the Recipient.

A Giver in any of the three embodiments can have a gift package sent to a Recipient with a printed message stating that the package contains a wristband with a black patch and a payment card with a removable SIM chip, a printed QR Code and a printed Activation Code. The message instructs the Recipient to scan the QR Code with a mobile camera and enter the Activation Code, then to follow the preloaded instructions which will state the amount of preloaded money and the name of the Giver. The preloaded instructions then state to remove the SIM chip from the payment card and to insert it into the black patch on the wristband. Then a contactless payment can be made with the chip loaded wristband.

### BRIEF DESCRIPTION OF THE DRAWINGS

FIG. 1 is a schematic illustration of the components of one embodiment of a gift package of a wearable device and a prepaid card comprising a card with the QR code and a removable SIM card chip.

FIG. 2 is a schematic illustration of a prepaid card or SIM card inserted into patch 26.

FIG. 3 is a flowchart depicting the process for a Giver setting up the gift package to be sent.

FIG. 4 is a flowchart depicting the process for a Recipient setting up and using the gift package.

FIG. 5 is a flowchart depicting another Giver embodiment of the invention.

FIGS. 6A-6C, are flowcharts depicting the process for use by an individual Giver.

FIGS. 7A and 7B are flowcharts depicting the process for use by a Corporate (or employer) Giver.

FIG. 8 is a flowchart depicting the platform of a computer program.

FIGS. 9A-9E, are flowcharts depicting another embodiment of the process that a Recipient uses once a gift package has been received.

### DETAILED DESCRIPTION OF THE PREFERRED EMBODIMENTS

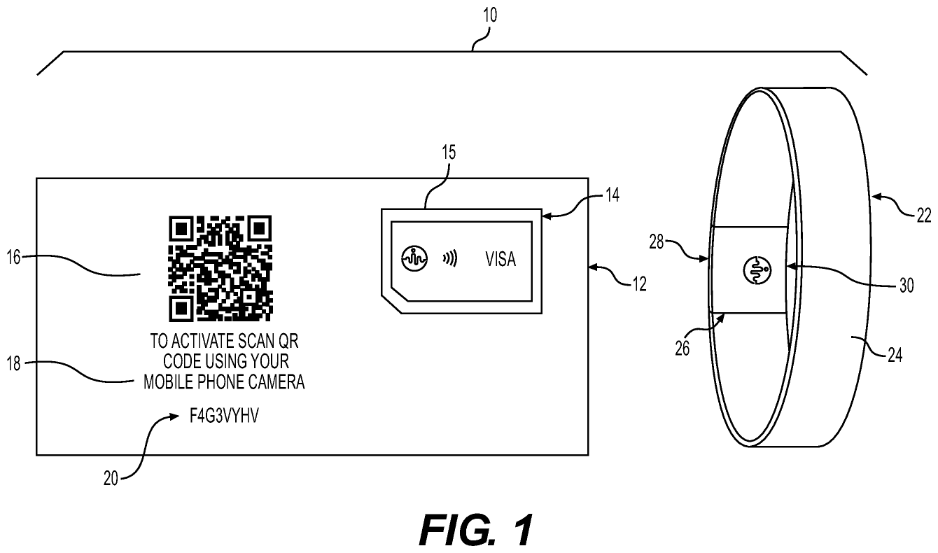

FIG. 1 depicts the components of as general embodiment of a gift package 10 according to the invention. Gift package 10 is comprised of a rectangular prepaid card 12 containing a removable SIM card 14 at one end and a QR Code 16 at the other end. The depicted version of card 12 also includes below QR Code 16 an operational message for the Recipient: “To activate scan QR code using your mobile phone camera.” Below the operational message is an activation code 20 which is unique to a prepaid card. As can be seen in FIG. 1, SIM card 14 is attached to the body of prepaid card by only 3 tabs, which can be easily broken to remove SIM card 14.

SIM card 14 is similar to that which is used in conventional cell phones and operates similarly.

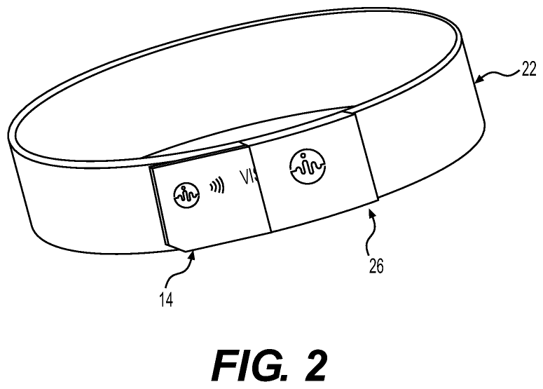

Gift package 10 also includes a wearable device depicted as a wrist band or bracelet 22. Bracelet 22 has an elastic band 24 and attached around one side is a black patch 26. Patch 26 is permanently attached to bracelet 22, for example by being sewn, at one edge 28 and the other edge 30 thereof to band 24. This attachment provides a spacing between patch 26 and band 24 such that SIM card 14 can be inserted into one side of patch 26 between edges 28 and 30 as shown in FIG. 2. Although wrist band 22 is depicted in FIG. 1 as being bland or plain, wrist band can also be very colorful, decorative or with messages on it.

Although gift package 10 is depicted as including a wearable bracelet or wrist band, other wearable devices can include key chains, slip-on watch fobs, neck bracelets, neck pendants on a neck chain and a full silicon wristband.

### General Procedure for Giving a Gift

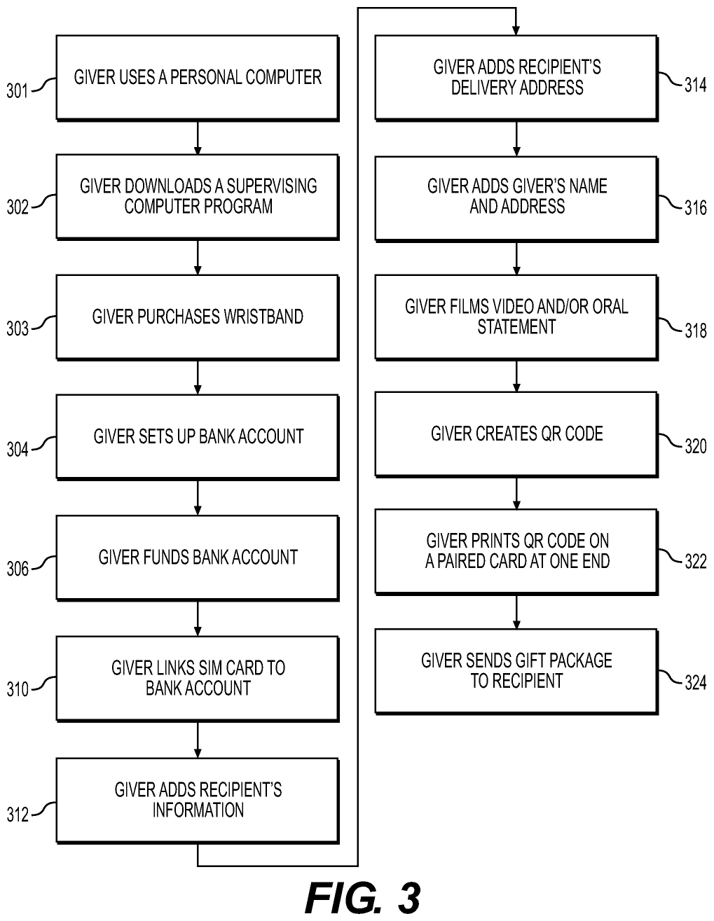

With reference to FIG. 3, a flow chart is depicted for the general process of giving a gift. Initially, as shown in box 301, the Giver uses a personal computer to download a supervisory computer program, as shown in box 302. Giver at this time as shown in box 303 can use the personal computer to purchases a wristband 22 from the internet 14 on which a SIM card can later be attached. In box 304, the Giver sets up a bank account for the Recipient of the gift. Of course, the Giver may have previously set up the bank account and can use it. However, a separate bank account must be used for each gift Recipient.

If the bank account is not already funded, the Giver adds money to the bank account, as set forth in box 306.

The Giver must now provide the SIM card with the funding. Thus, in box 310 the Giver using a general-purpose digital computer loads a SIM card 14 in a conventional way with the amount of the gift, which has been previously added into the account. Also, as in box 312, the Giver adds the Recipient's information such as the name, telephone number and email address.

In box 314, the Giver adds to the supervising program the Recipient's delivery address to which the gift package will be sent, such as by mailing or sending by courier. The Giver in box 316 adds the Giver's name, email address, and mobile telephone number to the supervising program.

One feature of the present invention is that the Giver can provide an oral and/or video statement. Thus, in box 318, the Giver using a cell phone, for example, records a statement and/or films a video message. And then Giver stores it or them in the cloud using the cell phone.

The Giver provides the location of the stored messages in the supervising program.

The Giver in box 320 creates a QR code and in box 322 prints the QR code on a paired card at one end then sends in box 324 gift package 10 comprising the wrist band and prepaid card with a QR Code 16 on it to the Recipient using conventional means such as mail, courier, and physically delivering it.

### General Procedure for Recipient Using the Gift

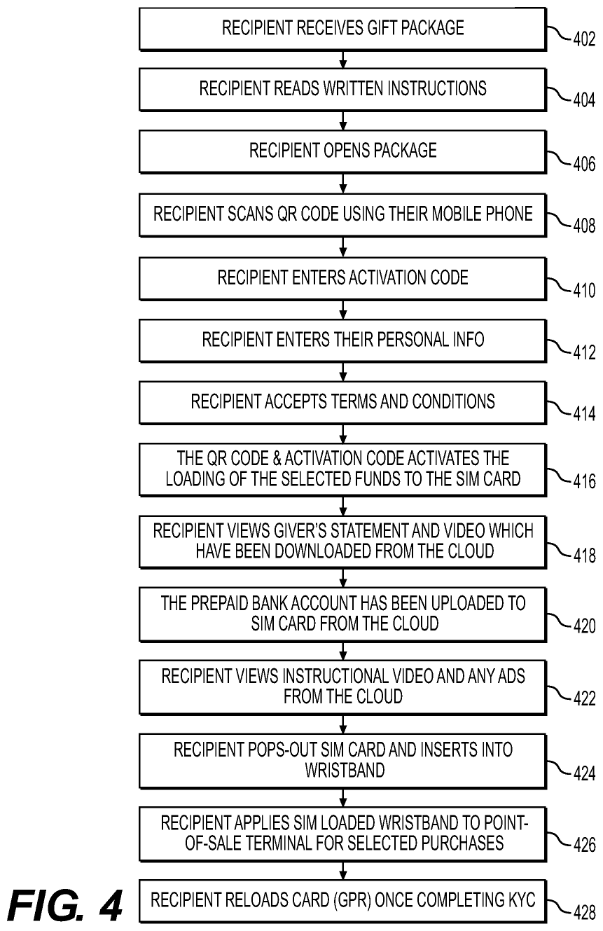

With respect for the general procedure for the gift Recipient using the gift, refer to FIG. 4.

As shown in box 402, the designated Recipient receives gift package 10 and in box 404 reads written instructions on the outside of the package. These written instructions tell the Recipient what is in the gift package 10 and what has to be done to use it.

An example of such instructions can be:
1. What's in the package?
   Inside is your wristband and payment SIM card. Think of a Gift Card in a wristband that has been preloaded with funds.
2. Activate our Account.
   Scan the QR Code on the card with your mobile camera. Then enter the Activation code underneath the QR Code. Follow the process all the way to see how much has been preloaded and who gifted this to you.
3. What's next?
Pop out the chip from the payment SIM card. Just like a mobile SIM card. Insert the chip into the bracelet.
4. You're good to go!
   Now you can make contactless payments using your wristband. Just like your debit or credit card. ENJOY!

After reading the outside instructions, the Recipient opens the package in box 406 and scans the QR code using, for example, their mobile phone as in box 408. The Recipient enters the activation code 18 in Box 410 and then enters their personal information in Box 412. The Recipient accepts the terms and conditions in Box 414. The QR Code and the Activation code activates the loading of the selected funds to the SIM Card in Box 416.

The Recipient listens to the Giver's statements and watches the video in the QR Code in Box 418. In Box 420 the prepaid bank account has been linked to the SIM Card from the Cloud using the program. The Recipient views in Box 422 the instructional video and any ABS from the cloud.

The Recipient then pops out the SIM Card in Box 424 and inserts it into the wrist band 22. In box 426 then the Recipient applies the SIM Card in the bracelet to a POS terminal to pay for the selected items to be purchased.

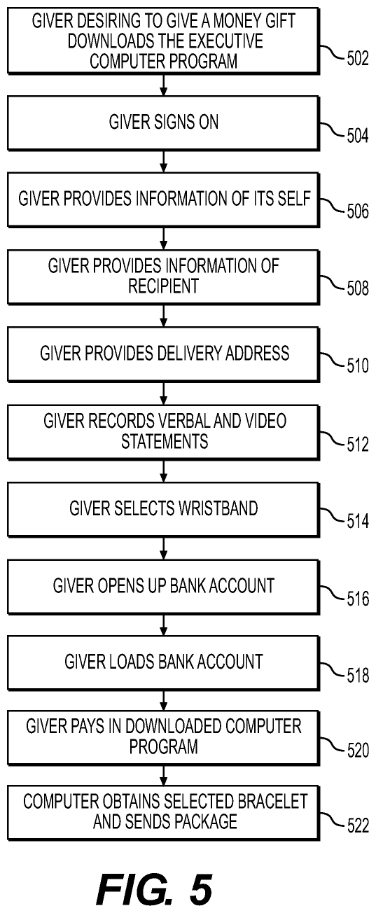

A second embodiment of the Giver's procedure setting up the gift package 10 is depicted in FIG. 5.

The steps of performing the method are not limited to the order in which they have been set forth.

A Giver desiring to give a money gift downloads the executive computer program as in Box 502. The Giver signs on to the program in a conventional way, as in Box 504 and provides Giver's information as in Box 506.

The Giver then provides information about Recipient in in Box 508 and the delivery address of Recipient in Box 510. The Giver records a verbal greeting and if desired makes a statement as in Box 512. The Giver then selects a wristband in Box 514. Then the Giver opens a new bank account in Box 516, or the program provides one, and the Giver loads the bank account with the desired amount of the gift as in Box 518. The Giver in Box 520 goes to the payment section of the computer program and pays for the amount of the gift, the cost of the bracelet, and the processing charges.

Finally, the computer assembles the selected bracelet and prepaid card 12 and ships it to the Recipient in box 522.

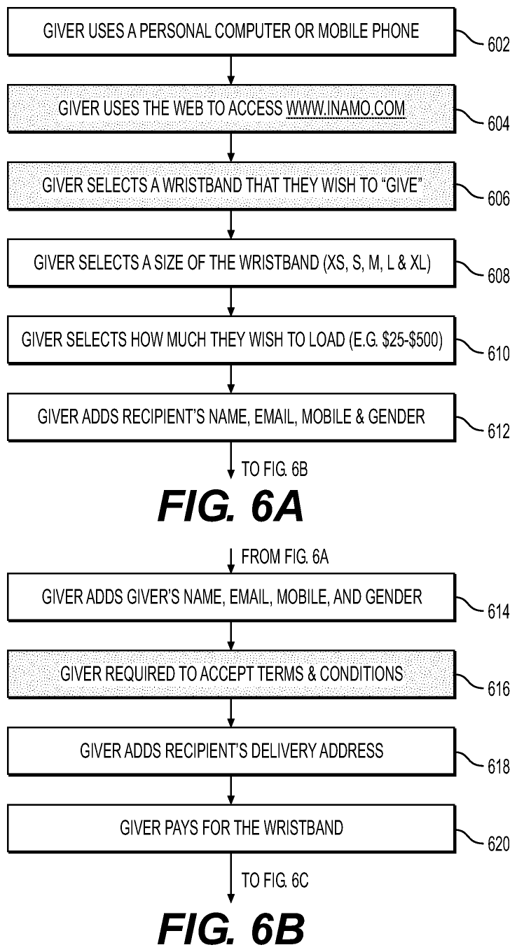

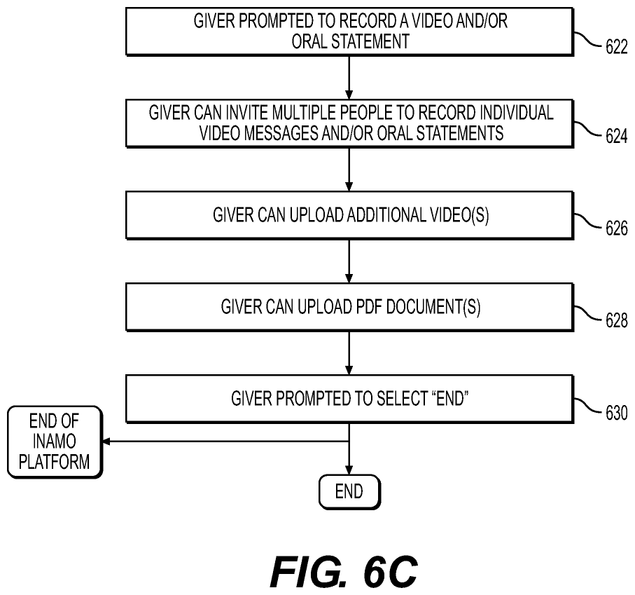

A second embodiment of the invention is depicted in FIGS. 6A-6C. This embodiment sets forth the situation of an individual Giver giving the gift to another individual.

In box 602, the Giver sets up and uses a personal computer, a laptop, or in some cases a mobile phone. The Giver uses the computer to access the website of the computer program, such as www.inamo.com, in box 604. The access to the computer program can be via mobile, a PC or an iPad.

In box 606, the Giver selects a wristband that they want to include in the gift package. The computer, etc. can be used to scan the internet, a known website for wristbands, or the computer program. Once the Giver selects the wristband, the computer program performs the rest of the steps. Giver selects a size of the wristband in box 608 as well as the style.

Then in box 610 the Giver selects how much he or she wishes to load, for example from $25 to $500. At this point, no funds are yet allocated to an account, such as a bank account.

In box 612 the Giver enters the name, email address, mobile number, and gender of the Recipient into the computer program. In box 614, the Giver adds his or her name, email address and gender into the computer program.

In order for the Recipient to continue, the Recipient as set forth in box 616 is required to read and accept the Terms and Conditions of the procedure. When accepted, the computer program asks for the Recipient's delivery address in box 618. The Giver in box 620 is then directed by the computer program to a predetermined bank, which charges the credit or debit card of the Giver for the wristband, for the funds loaded and any processing fee.

One of the features of the present invention is that the Giver can send the Recipient a video and/or an oral statement which is stored on the QR code as set forth in box 622. Also, as indicated in box 624, the Giver can invite multiple people to record individual video messages or oral statements. In addition, as in boxes 626 and 628, the Giver can upload additional videos or pdf documents. These can include advertisements or announcements.

After the foregoing steps have been performed, the computer program prompts the Giver in box 630 to select END, to end the computer program as depicted in the END box 632. At this point, the Giver is no longer being directed by the computer program but is being redirected to the website of the computer program.

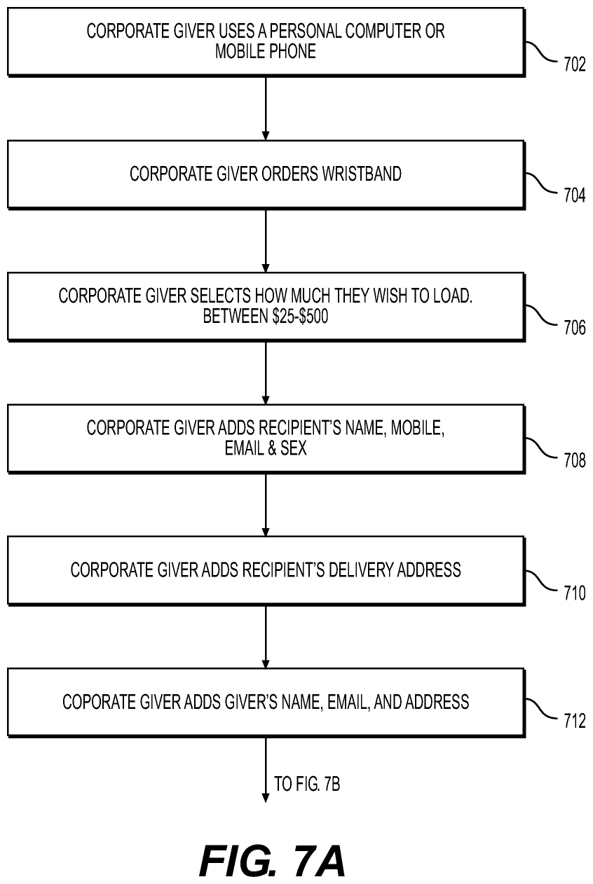

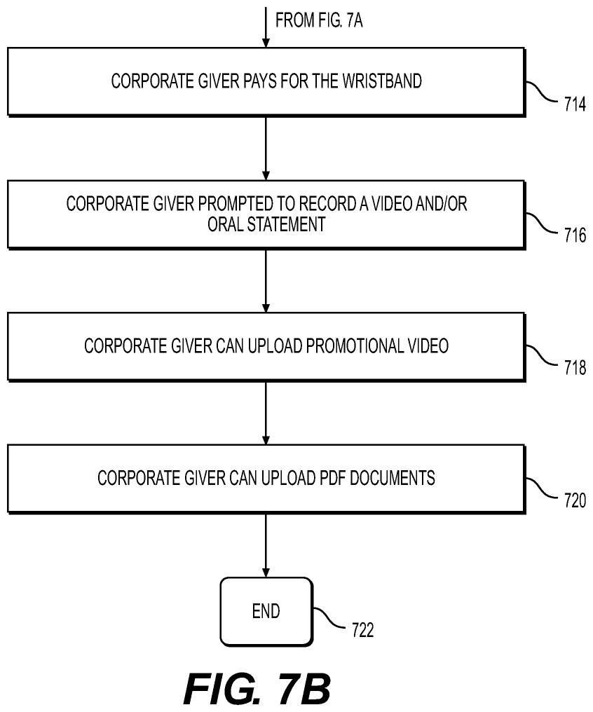

A third embodiment of the present invention involves a corporate or employer giver. This procedure is set forth in FIGS. 7A and 7B.

In box 702, a Corporate Giver uses a personal computer or mobile phone to select the computer program and begin the process. After deciding on whom the gifts are to be given, the corporate Giver orders the number and type of wristbands to be included in the gift packages, as shown in \box 704. In box 706, the corporate Giver decides and selects how much it wishes to load, from for example $25 to $500.

The Corporate Giver in boxes 708 and 710 inputs the recipients' name(s) mobile phone number, email and sex, and the delivery address(es) into the computer program. It also in box 712 adds its name, email address and postal address, as desired, into the computer program.

In box 714, the Corporate Giver pays for the wrist bands and is redirected to a bank which charges the credit/debit card on file for the wristbands, funds loaded and the processing fee if any. The computer program then prompts the Corporate Giver to record a video and/or oral statement in box 716. It is also prompted to upload any promotional videos and pdf documents by the computer program in boxes 718 and 720. The program is then ended in box 722.

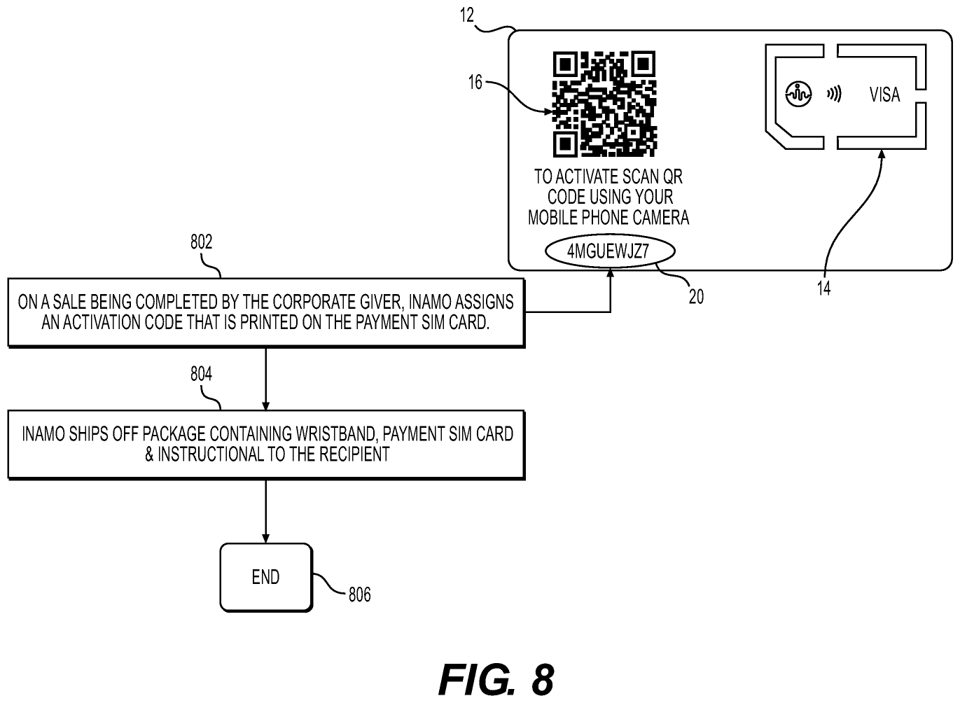

The computer program or platform performs several functions after the Giver or Corporate Giver has finished its or their functions as set forth in FIGS. 1-7. These are depicted in FIG. 8.

On a sale being completed, the computer program in box 802 assigns an activation code that is then printed on the payment SIM card 12. The activation code is linked to the specific QR code on card 12 that is linked to the Recipient and the funds the Giver has preloaded.

In box 804 the computer program then activates the shipping of the gift package, which contains the wristband, payment SIM card and instructions to the Recipient. The computer program is thus finished as shown in box 806 in the giving part of the program.

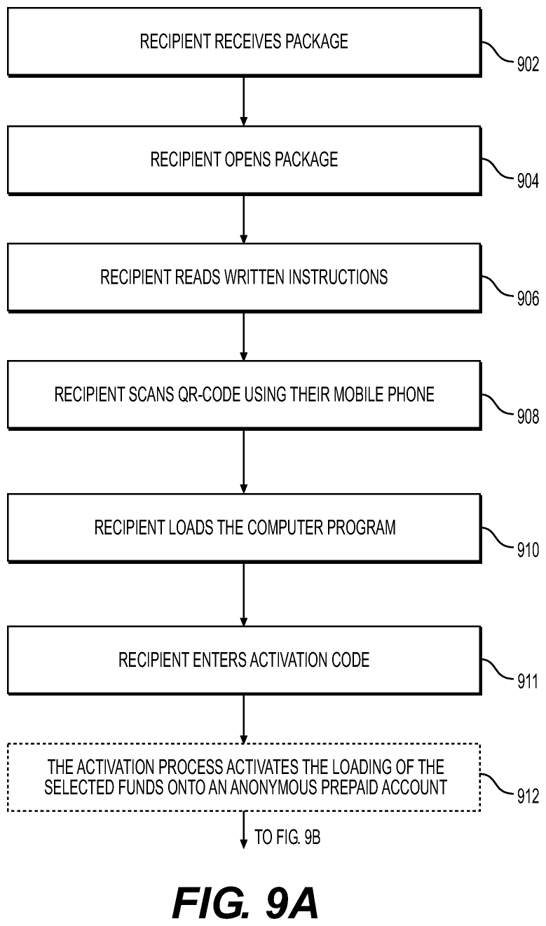

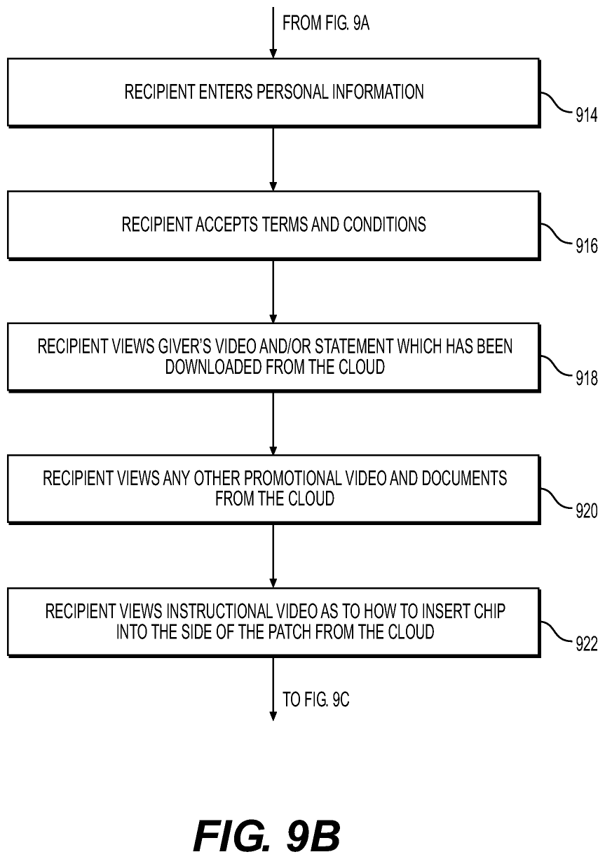

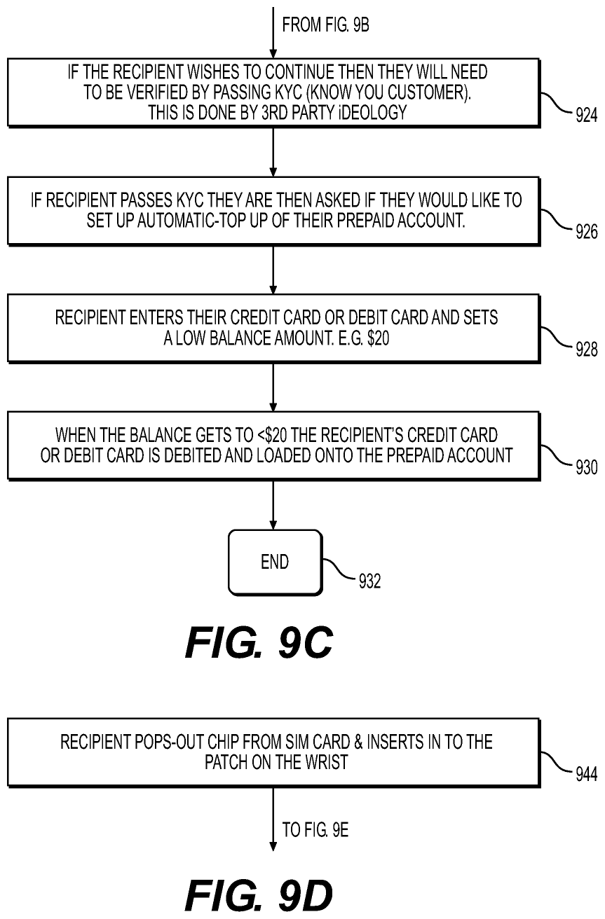

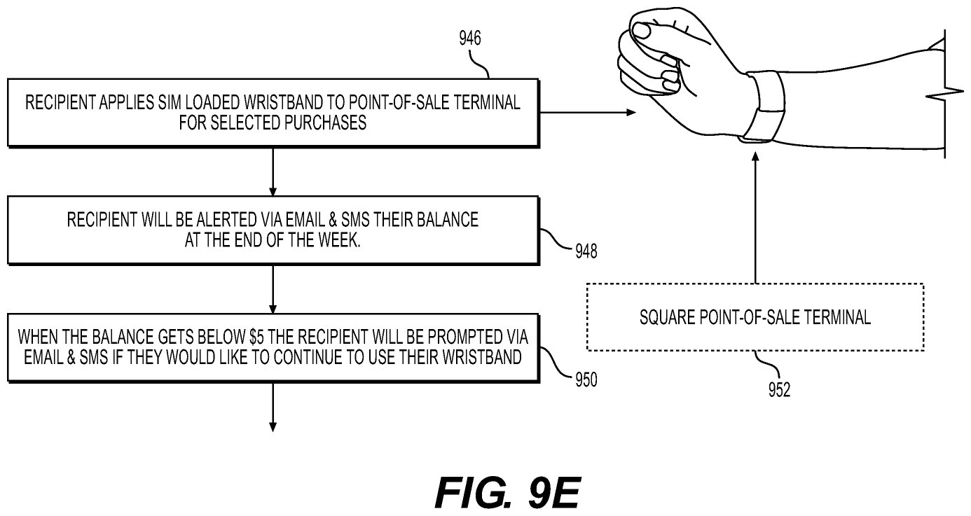

Another embodiment of the invention regarding the activity of the Recipient, irrespective of whom the GIVER is, is depicted in FIGS. 9A-9E.

With respect to FIG. 9A, in box 902 and 904, the Recipient receives the package. And opens it. The Recipient then reads the written instructions that accompany the package in box 906. The instructions direct the Recipient to scan the QR code using his or her mobile phone that contains an app that can read the QR code, which the Recipient does in box 908. In box 910, the Recipient downloads and opens the computer program and in box 911 enters activation code 210 into the program. Upon entering activation code 210 into the downloaded computer program, the computer program at box 912 activates the loading of the selected funds onto an anonymous prepaid account. The combining of the QR code to the Activation code in the program's database provides that person's personal information. The account is anonymous because it is not linked to a person. However, once it is activated, that person can then make contactless payments using the SIM card with a conventional intelligent credit card reader, or point-of-sale terminal.

The Recipient then enters his or her personal information into the computer program in box 914. The Recipient in order to continue, reads and accepts the terms and conditions in box 916. In box 918, Recipient views the Giver's video and/or statements which have been downloaded from the cloud by the computer program. In boxes 920 and 922 the Recipient views any promotional video and documents and views an instructional video as to how to insert the SIM card 14 into the side of the patch from the cloud.

If the Recipient wishes to continue, then he or she must be verified in box 924 by passing the KYC (Know Your Customer) test. This is a requirement of the Dodd-Frank Wall Street Reform and Consumer Protection Act. This test is administered by a third-party IDeology. If Recipient passes the KYC test, then in box 926 the Recipient is asked if he or she would like to set upon automatic top up of their prepaid account. This account is now regarded as personalized as persona details are attached to that account. If the Recipient agrees, then in box 928 Recipient enters his or her credit card or debit card numbers and the card is debited and loaded onto the prepaid account in box 930. This ends the Recipient's use of the computer program and allows the Recipient to log off.

However, the Recipient has a few more tasks to accomplish. As depicted in FIG. 9D, and in box 944, the Recipient must pop-out the SIM chip 14 from the SIM card 12 and insert it into the patch 26 on the wrist band 22.

When used, the Recipient applies SIM card 12 located in wristband 22 to a point-of-sale terminal for selected purchases, as in box 946. In box 948, the Recipient will be alerted via email and SMS of his or her account balance at the end of a defined period such as one week. Finally, in box 950, when the balance gets below a certain minimum, such as $5, the Recipient will be prompted via email and SMS if the Recipient would like to continue to use their wristband and have more money submitted to their account. In box 952, there is a FIG. showing the use of bracelet 21 and attached SIM card to a square point-of-sale terminal.

### ADDITIONAL NOTES

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention, and does not pose a limitation on the scope of the invention unless otherwise claimed. No language in the specification should be construed as indicating any non-claimed element as essential to the practice of the invention.

Certain embodiments of this invention are described herein, including the best mode known to the inventors for carrying out the invention. It should be understood that the illustrated embodiments are exemplary only and should not be taken as limiting the scope of the invention.

Benefits, other advantages, and solutions to problems have been described herein with regard to specific embodiments. However, the benefits, advantages, solutions to problems, and element(s) that may cause benefit, advantage, or solution to occur or become more pronounced are not to be construed as critical, required, or essential features or elements of the claims. Reference to an element in the singular is not intended to mean “one and only one” unless explicitly so stated, but rather “one or more.” As used herein, the terms “comprise”, “comprising”, or a variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for practice unless expressly described as “essential” or “critical”. Moreover, those skilled in the art will recognize that changes and modifications may be made to the exemplary embodiments without departing from the scope of the present invention. Thus, different embodiments may include different combinations, arrangements and/or orders of elements or processing steps described herein, or as shown in the drawing figures. For example, the various components, elements or process steps may be configured in alternate ways depending upon the particular application or in consideration of cost. These and other changes or modifications are intended to be included within the scope of the present invention, as set forth in the following claims.

1. A gift package that is given by a Giver to a Recipient, the gift package comprising:
a card having a QR Code at one location thereon and a SIM Card at another location thereon, the QR Code containing a previously recorded message and the SIM Card being linked to a money account and being readable by a Point-Of-Sale terminal;
a wearable device that can retain said SIM Card; and
a computer program for receiving and storing identification information about the Giver and the Recipient, and for receiving the recorded message and downloading it to the QR Code.

2. The gift package as claimed in claim 1, wherein said card is rectangular and said QR Code is located at one end and said SIM Card is located at the other end thereof.

3. The gift package as claimed in claim 1, wherein said wearable device is a wrist band.

4. The gift package as claimed in claim 3, wherein said wrist band is elastic and includes a patch mounted therearound.

5. The gift package as claimed in claim 4, wherein said patch is mounted around said wrist band and one end thereof is spaced therefrom so that an object can be placed therebetween.

6. The gift package as claimed in claim 5, wherein said SIM Card is removable from said card and can be placed between said wrist band and said patch.

7. The gift package as claimed in claim 1, wherein said SIM Card is removable from said card.

8. The gift package as claimed in claim 7, wherein said SIM Card is attached to said card by at least three points and can be punched out of said card.

9. The gift package as claimed in claim 1, wherein said card further contains a readable activation code.

10. A method of creating a gift package for a Giver to give to a Recipient, comprising in any order:
providing a wearable device;
providing a card having a SIM Card removably attached thereto;
recording a video and/or oral statement by the Giver;
creating a QR Code containing said statement thereon;
printing the QR Code on said card, said QR Code being linked to said video and/or oral statement;
linking the SIM Card to a source of money; and
sending said card and wearable device as a gift package to the Recipient,
wherein the SIM Card is attachable to said wearable device such that a contactless payment can be made using said wearable device at a point of sales terminal.

11. The method of creating a gift package as claimed in claim 10, further comprising providing instructions available from said QR Code by the Recipient.

12. The method of creating a gift package as claimed in claim 10, further comprising:
accessing a cloud of memory storage and creating a retrievable file in the cloud, wherein said statement of the Giver and said information about the Giver are stored in said file in the cloud; and
providing information about the Giver and the Recipient in said file in the cloud, wherein said QR Code can access said file in the cloud for said information.

13. The method of creating a gift package as claimed in claim 12, wherein said SIM Card is linked to said file in the cloud.

14. The method of creating a gift package as claimed in claim 10, further comprising:
accessing a cloud of memory storage and creating a retrievable file in the cloud; and
said Giver provides to the file information about the Recipient, about the Giver and about the address to which said gift package is to be sent, said file information to be downloadable by the Recipient.

15. The method of creating a gift package as claimed in claim 10, further comprising:
using a computer program to create a downloadable file having information about the Giver and the Recipient and having a voice message, and prompting said Giver to provide said information;
providing a card having a removable SIM Card at one location thereon;
using said computer program to prompt the Giver to load said SIM Card with a desired amount of money linked to a bank account; and
at another location on said card printing a QR Code with said downloadable file.

16. The method of creating a gift package as claimed in claim 15, wherein said computer program provides said QR Code with a message providing instructions which is readable by said Recipient.

17. A method of using a created gift package given by a Giver by a Recipient, the method comprising:
receiving a gift package that includes written instructions, includes a wearable device, and includes a card with a QR Code which has access to an oral and/or a video statement, and said card having a removable SIM Card being linked to a money account and being readable by a point-of-sale terminal;
reading said instructions and reading the QR Code with a cell phone of the Recipient;
removing said SIM Card and attaching it to said wearable device; and
the Recipient using said wearable device with said SIM Card to activate a Point-Of-Sale terminal.
